(19) United States
(12) Patent Application Publication
(10) Pub. No.: US 2023/0357083 A1
(43) Pub. Date: Nov. 9, 2023

(54) DUAL APPLICATION OF ROOFING GRANULES TO BITUMINOUS ROOFING MATERIAL

(71) Applicant: JOHNS MANVILLE, Denver, CO (US)

(72) Inventors: Casey Hill, Macon, GA (US); Shelby Kay Dewhurst, Arvada, CO (US); April Heath, Arvada, CO (US)

(21) Appl. No.: 17/736,224

(22) Filed: May 4, 2022

(51) Int. Cl. C04B 26/26; C04B 20/00; C04B 14/10; C04B 41/00; C04B 41/50; C04B 41/52; C04B 41/70

(52) U.S. Cl. CPC C04B 26/26; C04B 20/0048; C04B 14/106; C04B 41/0072; C04B 41/5037; C04B 41/526; C04B 41/70; C04B 2111/00586

(57) ABSTRACT

A method of manufacturing a bituminous roofing membrane may include saturating a nonwoven material with a bituminous material to form a bituminous membrane. The method may include applying a first granular material to a top surface of the bituminous membrane. The method may include removing at least some of the first granular material that has not adhered to the bituminous membrane. The method may include heating the bituminous membrane. The method may include applying a second granular material to the bituminous membrane while the bituminous membrane is in a generally planar configuration.

### BACKGROUND

Bituminous roofing material is often used to cover roof structures to provide a water barrier and/or solar reflective covering for a roof structure. Bituminous roofing materials typically include a bituminous substrate that is coated with reflective granules. These granules may offer a solar reflectance of at least 65%, while the bituminous substrate may exhibit a solar reflectance of closer to 5%. Oftentimes, due to the processes used to manufacture conventional bituminous roofing membranes, a significant portion of the bituminous material, oftentimes exceeding 25% of the surface area of the material, may remain exposed after application of the granules. This may severely reduce the ability of the bituminous roofing material to effectively reflect solar radiation and may result in a warmer roof surface. Therefore, improvements in the methods of manufacture of bituminous roofing materials are desired.

### SUMMARY

Embodiments of the present invention are directed to methods of manufacturing bituminous roofing membranes that have improved reflectivity. Embodiments may produce roofing membranes that include increased coverage of reflective granules and that reduce an amount of bituminous material that is visible on a top surface of the roofing membrane. Embodiments may therefore provide roofing membranes having a more uniform appearance.

In one embodiment, a method of manufacturing a bituminous roofing membrane may be provided. The method may include saturating a nonwoven material with a bituminous material to form a bituminous membrane. The method may include applying a first granular material to a top surface of the bituminous membrane. The method may include removing at least some of the first granular material that has not adhered to the bituminous membrane. The method may include heating the bituminous membrane. The method may include applying a second granular material to the bituminous membrane while the bituminous membrane is in a generally planar configuration.

In some embodiments, heating the bituminous membrane may include heating the bituminous membrane to between about 180° F. and 280° F. The method may include cooling the bituminous membrane after each application of granular material. The first granular material may have a greater average grain size than the second granular material. The first granular material and the second granular material may include kaolin clay. Heating the bituminous membrane may be done using one or more of an IR heater, an oven, and a hot air blower. The method may include removing at least some of the second granular material that has not adhered to the bituminous membrane.

In one embodiment, a method of manufacturing a bituminous roofing membrane is provided. The method may include saturating a nonwoven material with a bituminous material to form a bituminous membrane. The method may include applying a first granular material to a top surface of the bituminous membrane. The method may include pressing the first granular material into the top surface of the bituminous membrane. The method may include removing at least some of the first granular material that has not adhered to the bituminous membrane. The method may include heating the bituminous membrane. The method may include applying a second granular material to the bituminous membrane while the bituminous membrane is in a generally planar configuration. The first granular material may have a greater average grain size than the second granular material.

In some embodiments, removing at least some of the first granular material may include passing the bituminous membrane about a turnover drum such that the at least some of the first granular material falls into a collection container. An average grain size of the first granular material may be between about 8 mesh and 40 mesh. An average grain size of the second granular material may be between about 30 mesh and 100 mesh. The method may include exposing a bottom surface of the bituminous membrane to a water bath after applying the first granular material. The method may include passing the bituminous membrane through a cold roller assembly after applying the second granular material. The method may include applying a base layer to a bottom surface of the bituminous membrane. The method may include applying a third granular material to the bituminous membrane while the bituminous membrane is in a generally planar configuration. The second granular material may be applied while the bituminous membrane is at a downward angle. The third granular material may be applied while the bituminous membrane is at an upward angle.

In one embodiment, a bituminous roofing membrane is provided. The roofing membrane may include a bituminous membrane having a nonwoven mat that is saturated with a bituminous material. The membrane may include a granular material that is disposed on a top surface of the bituminous membrane. The granular material may cover at least 80% of the top surface of the bituminous membrane. The membrane may include a backing layer affixed to a bottom surface of the bituminous membrane.

In some embodiments, the backing layer may include one or more selected from the group consisting of: sand, a burn-off film, and a release liner. The granular material may include kaolin clay. An average grain size of the granular material may be between 8 mesh and 100 mesh. The granular material may include a first granular material having an average grain size of between about 8 mesh and 40 mesh and a second granular material having an average grain size of between about 30 mesh and 100 mesh.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a bituminous roofing membrane according to embodiments of the present invention.

FIG. 2 illustrates a process of manufacturing a bituminous roofing membrane according to embodiments of the invention.

FIG. 2A illustrates a process of manufacturing a bituminous roofing membrane according to embodiments of the invention.

FIG. 3 is a flowchart illustrating a process for manufacturing a bituminous roofing membrane according to embodiments of the invention.

FIG. 4 illustrates a black area of a single drop membrane.

FIG. 5 illustrates a black area of a dual drop membrane according to embodiments of the invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to methods of manufacturing bituminous roofing membranes that exhibit improved solar reflectance compared to conventional bituminous roofing membranes. Embodiments may adhere reflective granules to a greater percentage of a top surface of the roofing membrane than conventional processes, which may increase the solar reflectance of the membrane and may give the membrane a more uniform and aesthetically pleasing appearance. Embodiments may also improve the adhesion of the granules to a bituminous substrate. Embodiments may achieve these results by applying the reflective granules in multiples steps. This may allow a larger granular material to be applied in a first step and pressed into a bituminous membrane with greater force than in conventional systems. This greater force may increase the adhesion of the larger granular material, but may cause an excess of the bituminous material to be forced within the voids formed between grains of the granular material. Subsequent steps may add smaller grains of the granular material, which may then adhere to and cover the bituminous material that is present within the voids between the larger grains.

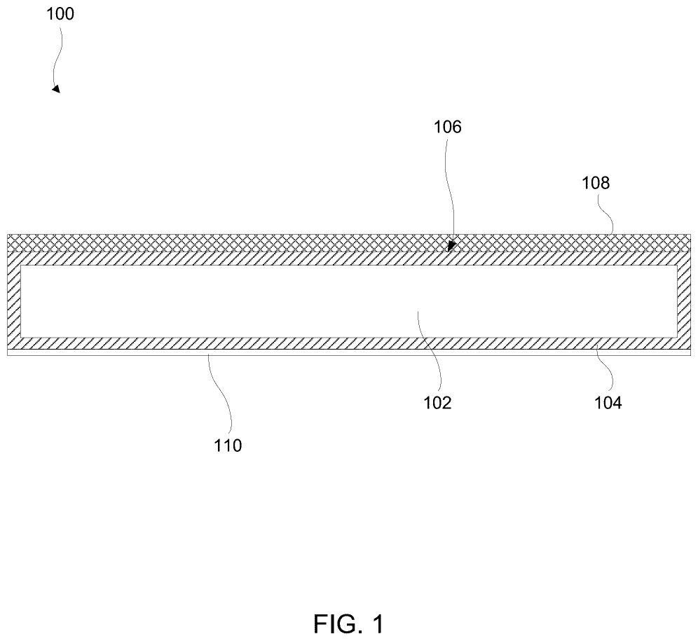

Turning now to FIG. 1, one embodiment of a bituminous roofing membrane 100 is shown. Roofing membrane 100 may be positioned atop roof structure, oftentimes above an insulation layer, and may be configured to prevent leaks in the roofing structure, to reflect solar radiation to keep the roof structure cool, and/or to provide aesthetic appeal. Oftentimes, the roofing membrane 100 may be provided as a roll of flat, flexible membrane that may be rolled out on top of the roof structure. For example, a roofing membrane 100 may be supplied in any workable size (such as, but not limited to, rolls of 1 meter wide or more and containing 10 linear meters or more of roofing membrane 100, or may be trimmed into shingles or panels). Oftentimes, the roof structure may be too large to be covered by a single piece of roofing membrane 100. In such instances, multiple pieces of roofing membrane 100 may be overlapped and joined at the seams using a waterproof joining method. For example, seams of adjacent pieces of roofing membrane 100 may be joined by priming and/or preparing edges of the roofing membranes 100 and then securing the edges together, such as by using hot asphalt, using heat welding and/or using another form of adhesive bonding.

Roofing membrane 100 may include a nonwoven mat 102 or other reinforcement material that serves as a primary substrate for the roofing membrane 100. The nonwoven mat 102 may include polyester, fiberglass, a combination of polyester and fiberglass, and/or other material. In a particular embodiment, the nonwoven mater may be a fiberglass scrim. The nonwoven mat 102 may be saturated with a bituminous material 104 to form a bituminous membrane 106. The bituminous material 104 may include modified bitumen, polymer modified asphalt (such as asphalts that include modifiers such as styrene butadiene styrene (SBS), atactic polypropylene (APP), amorphous poly alpha olefin (APAO), and/or isotactic polypropylene (IPP)), rubber modified asphalt, asphalt, and the like. While discussed primarily in relation to bituminous materials, it will be appreciated that other viscoelastic materials, such as thermoplastic rubbers, polypropylene, polyethylene, modified thermoplastic rubbers, and the like may be used in conjunction with and/or in place of the bituminous material in some embodiments.

A top surface of the bituminous membrane 106 may be coated with a granular material 108. For example, granular material 108 may include mineral-based granules, which may include a ceramic coating in some embodiments. The granules oftentimes white in color, either naturally or after being treated with a coloring agent. Possible minerals for the granular material 108 may include kaolin clay, slate, quartz, granite, and/or other minerals that are sufficiently weather resistant. Additionally, in some embodiments, the granular material 108 may be formed from synthetic materials. In some embodiments, a hydrophobic coating, such as a hydrophobic resin, may be applied to the granular material 108. Oftentimes, the granular material 108 may be selected to exhibit a solar reflectivity of at least about 60%, of at least about 65%, at least about 70%, at least about 75%, at least about 80%, at least about 85%, or more. The bituminous membrane 106 may include a range of different sizes of particles of granular material 108. For example, larger particles, having an average grain size of between about 8 mesh and 40 mesh may be included, with smaller particles having an average grain size of between about 30 mesh and 100 mesh being used to fill voids formed between the larger particles. This may enable a greater surface area of the bituminous membrane 106 to be coated with granular material 108. For example, in various embodiments, at least or about 80% of the surface area of the top surface of the bituminous membrane 106 may be covered by the granular material 108, at least or about 85% of the surface area of the top surface of the bituminous membrane 106 may be covered by the granular material 108, at least or about 90% of the surface area of the top surface of the bituminous membrane 106 may be covered by the granular material 108, or more. This may reduce the amount of bituminous material 104 that is visible at the top surface of the bituminous membrane 106, which may provide a more uniform appearance and may increase the solar reflectivity of the roofing membrane 100. For example, the solar reflectivity may be at least 70%, at least 71%, at least 72%, at least 73%, at least 74%, at least 75%, or more.

The roofing membrane 100 may include a backing layer 110 affixed to a bottom surface of the bituminous membrane 106. For example, the backing layer 110 may help prevent the roofing membrane 100 from sticking to itself when rolled, stored, and/or shipped. The backing layer 110 may include sand, a release liner, and/or burn-off film in various embodiments.

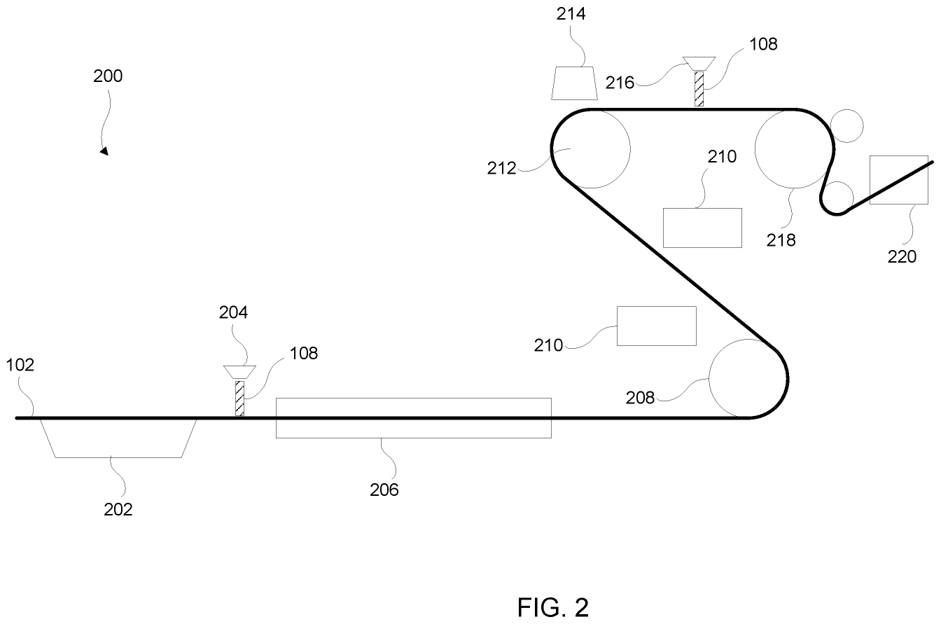

FIG. 2 illustrates a manufacturing system 200 that may be used to produce a roofing membrane, similar to roofing membrane 100 described above. System 200 may include a vat 202 that includes a bituminous material, similar to bituminous material 106, in a liquid form. For example, the bituminous material may include modified bitumen, polymer modified asphalt (such as asphalts including modifiers such as SBS, APP, APAO and/or IPP), rubber modified asphalt, asphalt, and the like. The vat 202 may be heated to maintain the bituminous material in a liquid form. A nonwoven mat, such as nonwoven mat 102, may be dragged or otherwise introduced into the vat 202, such that the nonwoven mat is saturated with the liquid bituminous material such that the nonwoven mat is fully coated with the bituminous material. The nonwoven mat and bituminous material may together form a bituminous membrane. The bituminous membrane may be passed under a first grain hopper 204 or other granular material delivery device, which may deposit a first granular material to a top surface of the bituminous membrane. The first granular material may be similar to granular material 108 described above and may include mineral and/or synthetic granules. The first granular material may include granules having large particle sizes. For example, the first granular material may include granules having an average size of between about 8 mesh and 40 mesh. The bituminous membrane may then be passed through a water bath 206 and/or other cooling station. For example, the bituminous membrane may be dragged across the water bath 206 to cool the bituminous membrane via the backside of the bituminous membrane.

The cooled bituminous membrane may then be passed about a turnover drum 208, which may turn the bituminous membrane upside down. For example, the top surface of the bituminous membrane may be wound against a surface of the turnover drum 208, which may help press the first granular material into the bituminous membrane. In some embodiments, the turnover drum may apply between about 5 pounds and 50 pounds of force, more commonly between 10 pounds and 30 pounds, and more commonly about 20 pounds of force to the bituminous membrane, which may provide improved granular adhesion over conventional processes. Turning the bituminous membrane upside down may enable loose granular material that did not adhere to the bituminous membrane to fall from the bituminous membrane, where the granular material may be collected in a granule recovery bin 210 and/or other collection device. Removal of the excess granular material may expose the surface of the bituminous membrane that is disposed within voids between individual grains of the granular material. Once the excess granular material has been removed, the bituminous membrane may be passed over a second turnover drum 212 to orient the bituminous membrane right side up again. The bituminous membrane may then exposed to a heating element 214, which may heat the bituminous membrane to a temperature that is sufficiently high to soften the bituminous material and make the bituminous membrane pliable, but is low enough to prevent the bituminous material from running and/or otherwise causing the bituminous membrane to deform. For example, the bituminous membrane may be heated by the heating element 214 to a temperature of between about 180° F. and 280° F. in some embodiments. The heating element 214 may include an infrared (IR) heater, oven, convection heater, microwave, and/or other heating device in various embodiments.

Once the bituminous membrane has been sufficiently heated, the bituminous membrane may be passed under a second hopper 216 or other granule delivery device. The second hopper 216 may then deposit a second granular material, such as granular material 108, atop the top surface of the bituminous membrane. The second granular material may be applied to the top surface of the bituminous membrane while the bituminous membrane is in a planar or otherwise flat (rather than arcuate or curved) configuration. For example, the second granular material may be applied while the bituminous membrane is tangentially arranged relative to the surface of the nearest roller or drum on either side of the second hopper 216. The planar configuration may include the bituminous membrane being horizontal, inclined upward, and/or inclined downward at the position that the second granular material is applied. The second granular material may be the same substance as the first granular material; but may include granules having small particle sizes. For example, the second granular material may include granules having an average size of between about 30 mesh and 100 mesh, which may fill voids formed between the larger granules of the first granular material.

The bituminous membrane may be passed through a press roller assembly 218, which may press the bituminous membrane to a desired thickness. For example, the press roller assembly 218 may apply between about 10 psi and 100 psi, more commonly between about 20 psi and 60 psi of force to the bituminous membrane to compress the bituminous membrane and to press the granular material into the bituminous material. In some embodiments, the bituminous membrane may be passed through a cooling assembly 220, which may include fans, chilled rollers, and/or other cooling devices that may reduce the temperature of the bituminous material. In some embodiments, a backing layer may be applied to the bottom surface of the bituminous membrane. For example, sand, a release liner, and/or a burn-off film may be applied to the bottom surface of the bituminous membrane, which may prevent the bituminous membrane from sticking to itself during rolling, storage, and/or shipment.

In some embodiments, system 200 may include an additional recovery station 210. For example, after the second granular material is applied to the bituminous membrane (before and/or after compressing and/or cooling the bituminous membrane), the bituminous membrane may be inverted using a turnover drum to cause excess granular material to be dropped from the bituminous membrane into a recovery container 210. It will be appreciated that while granule recovery is described as being performed using inversion involving turnover drums, granule recovery may additionally or alternatively include agitating (e.g., shaking and/or vibrating), brushing, and/or otherwise disturbing the bituminous membrane to dislodge and remove loose granular material.

Upon completion of the formation of the roofing membrane, the roofing membrane may be cut to desired dimensions and/or be wound onto a roll for subsequent storage and/or shipment. For example, the roofing membrane may be cut to a width of between about 24 inches and 144 inches (more commonly between about 24 inches and 39 inches) and a length that is specified by a customer and/or application. The final roofing membranes may be installed immediately after manufacture and/or stored for later use.

In some embodiments, rather than having granular materials applied to the bituminous membrane at only two stages, three or more applications of granular material may be used. FIG. 2A illustrates a system 200a that utilizes a three-stage application process. System 200a may be identical to system 200 unless otherwise disclosed. For example, after heating the bituminous membrane using heating element 214, the bituminous membrane may be passed under a second hopper 216 or other granule delivery device. The second hopper 216 may then deposit a second granular material atop the top surface of the bituminous membrane. The second granular material may be applied to the top surface of the bituminous membrane while the bituminous membrane is in a planar or otherwise flat (rather than arcuate or curved) configuration. In a particular embodiment, the bituminous membrane may be inclined upward as the second granular material is applied. The bituminous membrane may then pass about a roller 222, which may change the direction of the bituminous membrane. For example, the roller 222 may direct the bituminous membrane to be inclined downward, where a third hopper 224 may then deposit a third granular material (which may be similar to the second granular material) onto the inclined bituminous membrane. The bituminous membrane may then proceed to the press roller assembly 218 and/or cooling station 220 as described in relation to system 200 above.

By depositing the second and third granular material at opposing inclines, the smaller granule sizes may be able to better access the voids between the larger granules of the first granular material, which may lead to greater surface area coverage by the granular material. While disclosed as applying granules first to an upward inclined bituminous membrane and then to a downward inclined bituminous membrane, it will be appreciated that the order may be reversed in some embodiments. It will be understood that the systems described above are merely representative of a subset of possible systems and that numerous variations exist in which at least one additional granular material (having smaller granules) is applied to a bituminous membrane in a planar configuration after a first granular material (having larger granules) has been applied.

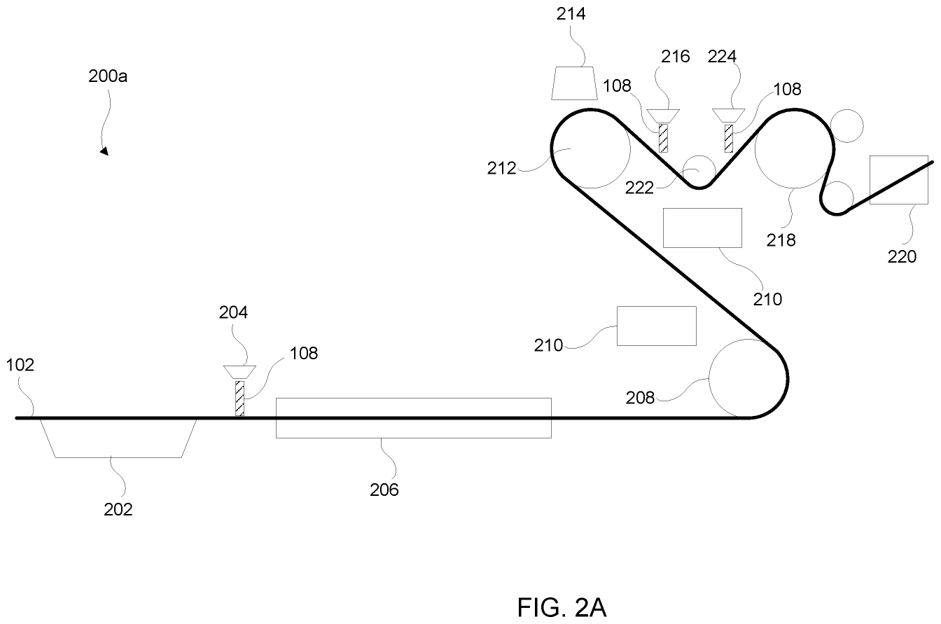

FIG. 3 illustrates a flow chart for a process 300 of manufacturing a bituminous roofing membrane. Process 300 may be used to produce a bituminous roofing membrane as described herein, such as roofing membrane 100. Process 300 may involve the use of a manufacturing system, similar to system 200 or 200a. Process 300 may begin at operation 302 by saturating a nonwoven material with a bituminous material to form a bituminous membrane. The nonwoven material may include fiberglass, polyester, and/or other materials, and may be a scrim in some embodiments. The nonwoven material may be dragged through a vat of liquid bituminous material such that the nonwoven material is fully saturated and coated with the bituminous material in some embodiments.

At operation 304, a first granular material may be applied to a top surface of the bituminous membrane. For example, the first granular hopper may be deposited on the top surface using a hopper or other delivery device. The first granular material may include mineral and/or synthetic granules having a solar reflectivity of at least 65%. The first granular material may have an average grain size of between about 8 mesh and 40 mesh in some embodiments. In some embodiments, the bituminous membrane may be cooled after application of the first granular material. For example, the bituminous membrane may be dragged through a water bath and/or otherwise actively or passively cooled. In some embodiments, the first granular material may be pressed into the top surface of the bituminous membrane, such as by using one or more rollers. At least some of the first granular material that has not adhered to the bituminous membrane may be removed at operation 306. For example, the bituminous membrane may be passed about a turnover drum such that the at least some of the first granular material falls into a collection container.

At operation 308, the bituminous membrane may be heated. For example, the bituminous membrane may be exposed to an IR heater, an oven, and/or a hot air blower to heat the bituminous membrane to a temperature that is high enough to soften the bituminous material without causing the bituminous material to run or otherwise deform. Oftentimes, the bituminous membrane is heated to a temperature of between about 180° F. and 280° F. A second granular material may be applied to the bituminous membrane while the bituminous membrane is in a generally planar configuration at operation 310. The second granular material may have a smaller average grain size than the first granular material. For example, an average grain size of the second granular material may be between about 30 mesh and 100 mesh. In some embodiments, the bituminous membrane may be cooled after application of the second granular material. For example, the bituminous membrane may be passed through a cooled roller assembly. In some embodiments, at least some of the second granular material that has not adhered to the bituminous membrane may be removed. A base layer, such as sand, a release liner, and/or burn-off film, may be applied to a bottom surface of the bituminous membrane. The roofing membrane may be cut to desired dimensions and/or be wound onto a roll for subsequent storage and/or shipment.

In some embodiments, additional granular material may be applied to the bituminous membrane. For example, a third granular material (which may be similar to the second granular material) may be applied to the bituminous membrane while the bituminous membrane is in a generally planar configuration. In some embodiments, the second granular material may be applied while the bituminous membrane is at a downward angle, and the third granular material may be applied while the bituminous membrane is at an upward angle. This may help increase the amount of surface area covered by the granular material, as the different angles may enable voids to be better accessed by the granules.

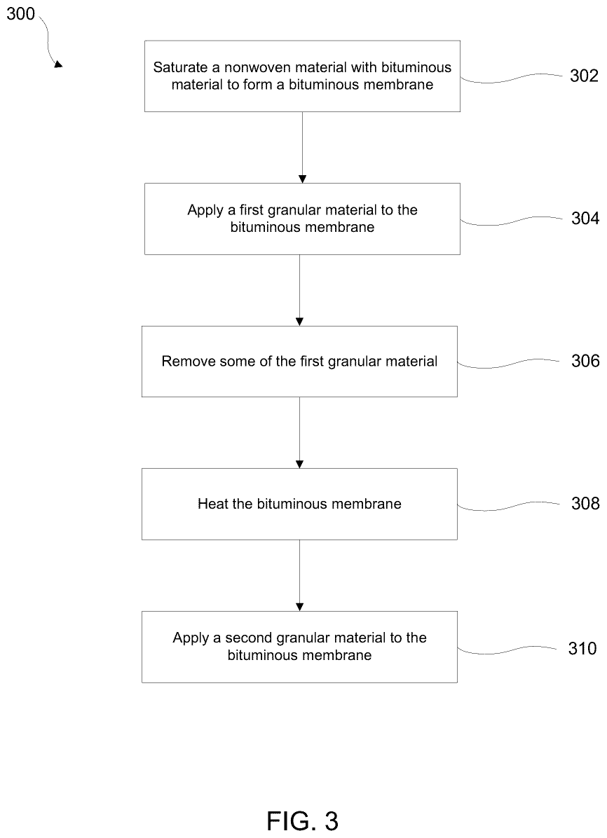

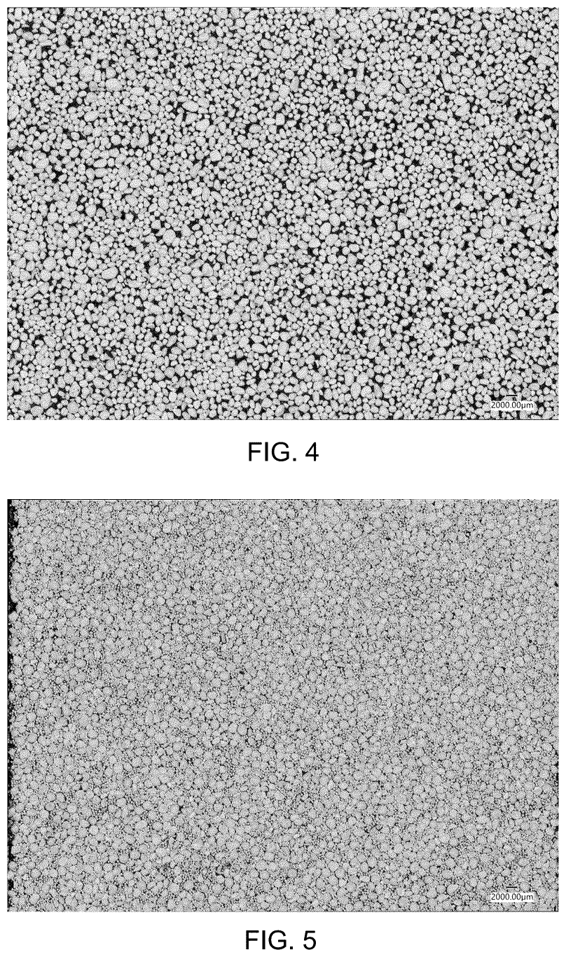

The use of multiple drops of granular material on the bituminous membrane may reduce the black area (i.e., area of the membrane where the bituminous membrane is visible) by up to 50% as compared to using a single drop. For example, a single drop of granular material may result in a black area of 25-30%, while the use of two (or more) drops of granular material may result in a black area of less than 15%. This reduction in area is illustrated in FIGS. 4 and 5. FIG. 4 shows the black area (as tested 24.90%) of a membrane fabricated using a single drop of granular material, while FIG. 5 shows the black area (as tested 14.15%) of a membrane fabricated using a dual drop of granular material as disclosed herein. The reduced black area may result in greater reflectivity. For example, the tested single drop membrane had a reflectivity of 67%, while the dual drop membranes tested had a reflectivity exceeding 70%, oftentimes between 71% and 73%. The granular adhesion using conventional single drop techniques was less than 1.5 g of loss as measured using ASTM D4977, while the granular adhesion of the dual drop techniques was noticeably improved to less than 1.0 g of loss.

It will be appreciated that the design of the apparatus 500 described above is merely representative of one example of an apparatus for installing a roofing membrane (or other rolled material). It will be appreciated that other spool/reel positions are possible, and that rollers and/or other devices may be included to change direction and/or otherwise redirect the material to or from a given spool/reel to a desired location.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. It will be further appreciated that all testing methods described here may be based on the testing standards in use at the time of filing or those developed after filing.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A method of manufacturing a bituminous roofing membrane, comprising:
saturating a nonwoven material with a bituminous material to form a bituminous membrane;
applying a first granular material to a top surface of the bituminous membrane;
removing at least some of the first granular material that has not adhered to the bituminous membrane;
heating the bituminous membrane; and
applying a second granular material to the bituminous membrane while the bituminous membrane is in a generally planar configuration.

2. The method of manufacturing a bituminous roofing membrane of claim 1, wherein:
heating the bituminous membrane comprises heating the bituminous membrane to between about 180° F. and 280° F.

3. The method of manufacturing a bituminous roofing membrane of claim 1, further comprising:
cooling the bituminous membrane after each application of granular material.

4. The method of manufacturing a bituminous roofing membrane of claim 1, wherein:
the first granular material has a greater average grain size than the second granular material.

5. The method of manufacturing a bituminous roofing membrane of claim 1, wherein:
the first granular material and the second granular material comprise kaolin clay.

6. The method of manufacturing a bituminous roofing membrane of claim 1, wherein:
heating the bituminous membrane is done using one or more of an IR heater, an oven, and a hot air blower.

7. The method of manufacturing a bituminous roofing membrane of claim 1, further comprising:
removing at least some of the second granular material that has not adhered to the bituminous membrane.

8. A method of manufacturing a bituminous roofing membrane, comprising:
saturating a nonwoven material with a bituminous material to form a bituminous membrane;
applying a first granular material to a top surface of the bituminous membrane;
pressing the first granular material into the top surface of the bituminous membrane;
removing at least some of the first granular material that has not adhered to the bituminous membrane;
heating the bituminous membrane; and
applying a second granular material to the bituminous membrane while the bituminous membrane is in a generally planar configuration, wherein the first granular material has a greater average grain size than the second granular material.

9. The method of manufacturing a bituminous roofing membrane of claim 8, wherein:
removing at least some of the first granular material comprises passing the bituminous membrane about a turnover drum such that the at least some of the first granular material falls into a collection container.

10. The method of manufacturing a bituminous roofing membrane of claim 8, wherein:
an average grain size of the first granular material is between about 8 mesh and 40 mesh; and
an average grain size of the second granular material is between about 30 mesh and 100 mesh.

11. The method of manufacturing a bituminous roofing membrane of claim 8, further comprising
exposing a bottom surface of the bituminous membrane to a water bath after applying the first granular material.

12. The method of manufacturing a bituminous roofing membrane of claim 8, further comprising:
passing the bituminous membrane through a cold roller assembly after applying the second granular material.

13. The method of manufacturing a bituminous roofing membrane of claim 8, further comprising:
applying a base layer to a bottom surface of the bituminous membrane.

14. The method of manufacturing a bituminous roofing membrane of claim 8, further comprising:
applying a third granular material to the bituminous membrane while the bituminous membrane is in a generally planar configuration.

15. The method of manufacturing a bituminous roofing membrane of claim 14, wherein:
the second granular material is applied while the bituminous membrane is at a downward angle; and
the third granular material is applied while the bituminous membrane is at an upward angle.

16. A bituminous roofing membrane, comprising:
a bituminous membrane comprising a nonwoven mat that is saturated with a bituminous material;
a granular material that is disposed on a top surface of the bituminous membrane, the granular material covering at least 80% of the top surface of the bituminous membrane; and
a backing layer affixed to a bottom surface of the bituminous membrane.

17. The bituminous roofing membrane of claim 16, wherein:
the backing layer comprises one or more selected from the group consisting of: sand, a burn-off film, and a release liner.

18. The bituminous roofing membrane of claim 16, wherein:
the granular material comprises kaolin clay.

19. The bituminous roofing membrane of claim 16, wherein:
an average grain size of the granular material is between 8 mesh and 100 mesh.

20. The bituminous roofing membrane of claim 16, wherein:
the granular material comprises a first granular material having an average grain size of between about 8 mesh and 40 mesh and a second granular material having an average grain size of between about 30 mesh and 100 mesh.
